(19) United States
(12) Patent Application Publication
(10) Pub. No.: US 2021/0323268 A1
(43) Pub. Date: Oct. 21, 2021

(54) OPTICAL LAMINATED FILM AND ELECTROCONDUCTIVE FILM

(71) Applicant: ZEON CORPORATION, Chiyoda-ku, Tokyo (JP)

(72) Inventor: Masaru KIKUKAWA, Tokyo (JP)

(73) Assignee: ZEON CORPORATION, Chiyoda-ku, Tokyo (JP)

(21) Appl. No.: 17/270,041

(22) PCT Filed: Aug. 21, 2019
(86) PCT No.: PCT/JP2019/032643

§ 371 Date: Feb. 22, 2021

(30) Foreign Application Priority Data
Sep. 7, 2018 (JP) 2018-168066

(51) Int. Cl. B32B 7/022; C08J 5/18; C08J 5/12; H01B 5/14; B32B 27/08; B32B 27/30

(52) U.S. Cl. CPC B32B 7/022; C08J 5/18; C08J 5/121; H01B 5/14; B32B 27/08; B32B 2307/732; C08J 2347/00; C08J 2367/02; C08J 2353/02; C08J 2423/20; B32B 2307/546; B32B 27/302

(57) ABSTRACT

An optical layered film comprising an A layer formed of a thermoplastic resin A and a B layer formed of a thermoplastic resin B provided on at least one surface of the A layer, wherein a flexural modulus of a film of the thermoplastic resin A having a thickness of 4 mm is 1,900 MPa or more and 3,500 MPa or less, a flexural modulus of a film of the thermoplastic resin B having a thickness of 4 mm is 100 MPa or more and 900 MPa or less, and a tensile break elongation of a film of the thermoplastic resin A having a thickness of 1.5 mm is 100% or more.

### FIELD

The present invention relates to an optical layered film and an electroconductive film.

### BACKGROUND

As an optical film such as a phase difference film, a polarizing plate protective film, an optical compensation film, or an electroconductive film used in a touch panel or the like, a film formed of a resin is generally used (see Patent Literature 1).

### CITATION LIST

### Patent Literature

Patent Literature 1: International Publication No. 2016/152871 (corresponding publication: U.S. Patent Application Publication No. 2018/0065348)

### SUMMARY

### Technical Problem

An optical film may be bent at the time of use depending on its use application. Thus, the optical film is required to have excellent bend resistance. However, a conventional optical film does not have sufficient bend resistance.

Thus, an optical film having excellent bend resistance and an electroconductive film including such an optical film have been demanded.

### Solution to Problem

The present inventor has conducted extensive studies to solve the aforementioned problem. As a result, the present inventor has found that an optical layered film including an A layer formed of a thermoplastic resin A satisfying particular conditions and a B layer formed of a thermoplastic resin B satisfying particular conditions has excellent bend resistance, thereby completing the present invention.

That is, the present invention provides the following.

[1] An optical layered film comprising an A layer formed of a thermoplastic resin A and a B layer formed of a thermoplastic resin B provided on at least one surface of the A layer, wherein

a flexural modulus of a film of the thermoplastic resin A having a thickness of 4 mm is 1,900 MPa or more and 3,500 MPa or less,

a flexural modulus of a film of the thermoplastic resin B having a thickness of 4 mm is 100 MPa or more and 900 MPa or less, and

a tensile break elongation of a film of the thermoplastic resin A having a thickness of 1.5 mm is 100% or more.

[2] The optical layered film according to [1], wherein the thermoplastic resin A includes a polymer having crystallizability.

[3] The optical layered film according to [1] or [2], wherein the thermoplastic resin A includes an alicyclic structure-containing polymer.

[4] The optical layered film according to any one of [1] to [3], wherein the thermoplastic resin B includes a hydrogenated product of a block copolymer of an aromatic vinyl compound and a conjugated diene compound.

[5] The optical layered film according to any one of [1] to [4], wherein the thermoplastic resin B includes an alkoxysilyl group-modified product of a hydrogenated product of a block copolymer of an aromatic vinyl compound and a conjugated diene compound.

[6] The optical layered film according to any one of [1] to [5], wherein a thickness of the A layer is 50 μm or less.

[7] An electroconductive film comprising the optical layered film according to any one of [1] to [6], and an electroconductive layer.

### Advantageous Effects of Invention

According to the present invention, an optical layered film having excellent bend resistance and an electroconductive film including such an optical layered film can be provided.

### BRIEF DESCRIPTION OF DRAWINGS

FIG. 1 is a cross-sectional view schematically illustrating an embodiment F-1 of an optical layered film.

FIG. 2 is a cross-sectional view schematically illustrating an embodiment F-2 of an optical layered film.

FIG. 3 is an explanatory diagram explaining a tear test using a tensile testing machine.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a direction of an element being “parallel” may allow an error within the range not impairing the advantageous effects of the present invention, for example, within a range of ±3°, ±2°, or ±1°, unless otherwise specified.

[1. Summary of Optical Layered Film]

The optical layered film according to an embodiment of the present invention includes an A layer formed of a thermoplastic resin A and a B layer formed of a thermoplastic resin B provided on at least one surface of the A layer.

The B layer may be provided to be in contact with the surface of the A layer, or the B layer may be provided onto the surface of the A layer while another layer such as a tackiness layer may be interposed between the A layer and the B layer. Preferably, the B layer is provided to be in contact with the surface of the A layer.

[1.1. A Layer]

### (Thermoplastic Resin A)

An A layer is formed of a thermoplastic resin A. The thermoplastic resin A forming the A layer has a flexural modulus E_{A} of normally 1,900 MPa or more and 3,500 MPa or less, preferably 1,900 MPa or more, more preferably 1,950 MPa or more, and further preferably 2,000 MPa or more, and of preferably 3,500 MPa or less, more preferably 3,450 MPa or less, and further preferably 3,400 MPa or less, when the thermoplastic resin A is formed as a film having a thickness of 4 mm. When the flexural modulus E_{A} is within the aforementioned range, the A layer has well-balanced rigidity and flexibility, and the optical layered film has excellent bend resistance.

The flexural modulus E_{A} and the flexural modulus E_{B} described below may be measured in accordance with JIS K7171. A film annealed at 170° C. for 30 seconds may be used as a film for measuring the flexural modulus E_{A} and the flexural modulus E₃.

The tensile break elongation S_{A} of the thermoplastic resin A is normally 100% or more, preferably 110% or more, more preferably 120% or more, and further preferably 130% or more, and may be normally 1000% or less, when the thermoplastic resin A is formed as a film having a thickness of 1.5 mm. When the tensile break elongation S_{A} is equal to or more than the aforementioned lower limit value, the optical layered film has excellent bend resistance.

The tensile break elongation S_{A} may be measured in accordance with JIS K7127. A film annealed at 170° C. for 30 seconds may be used as a film for measuring the tensile break elongation S_{A}.

As the thermoplastic resin A, a resin containing a thermoplastic polymer and further containing an optional component as necessary may be used. As the polymer, one type thereof may be solely used, and two or more types thereof may also be used in combination at any ratio.

Examples of the polymer that may be contained in the thermoplastic resin A may include an aliphatic olefin polymer such as polyethylene and polypropylene; an alicyclic structure-containing polymer; a polyester such as polyethylene terephthalate and polybutylene terephthalate; a polyarylene sulfide such as polyphenylene sulfide; a polyvinyl alcohol; a polycarbonate; a polyarylate; a cellulose ester polymer; a polyether sulfone; a polysulfone; a polyaryl sulfone; a polyvinyl chloride; a rod-shaped liquid crystal polymer; a polystyrene-based polymer such as a homopolymer of styrene or styrene derivative, or a copolymer of styrene or styrene derivative and an optional monomer; a hydrogenated product of a copolymer of an aromatic vinyl compound such as styrene and a conjugated diene compound such as butadiene and isoprene (including a hydrogenated product of an aromatic ring) or a modified product thereof; a polyacrylonitrile; a polymethylmethacrylate; and multicomponent copolymers of these. In addition, examples of the optional monomer that may be a monomer of a polystyrene-based polymer may include acrylonitrile, maleic anhydride, methyl methacrylate, and butadiene.

The thermoplastic resin A preferably contains an alicyclic structure-containing polymer among others. The alicyclic structure-containing polymer is usually excellent in mechanical strength, transparency, size stability, and light-weight property.

The alicyclic structure-containing polymer is a polymer containing an alicyclic structure in a repeating unit, and for example, may be mentioned a polymer obtained by a polymerization reaction using a cyclic olefin as a monomer or a hydrogenated product thereof. Further, as the alicyclic structure-containing polymer, either a polymer containing an alicyclic structure in a main chain or a polymer containing an alicyclic structure in a side chain may be used. Among these, the alicyclic structure-containing polymer preferably contains an alicyclic structure in a main chain. Examples of the alicyclic structure may include a cycloalkane structure and a cycloalkene structure, and a cycloalkane structure is preferable from the viewpoint of thermal stability.

The number of carbon atoms contained per alicyclic structure is preferably 4 or more, more preferably 5 or more, and more preferably 6 or more, and is preferably 30 or less, more preferably 20 or less, and particularly preferably 15 or less. When the number of carbon atoms contained in one alicyclic structure is within the aforementioned range, mechanical strength, heat resistance, and moldability are highly balanced.

In the alicyclic structure-containing polymer, the ratio of the repeating unit having an alicyclic structure is preferably 30% by weight or more, more preferably 50% by weight or more, further preferably 70% by weight or more, and particularly preferably 90% by weight or more, and is usually 100% by weight or less. By increasing the ratio of the repeating unit having an alicyclic structure as described above, heat resistance can be enhanced.

The rest of the alicyclic structure-containing polymer other than the repeating unit having an alicyclic structure is not particularly limited, and may be appropriately selected depending on the purposes of use.

The thermoplastic resin A preferably contains a polymer having crystallizability. Herein, the polymer having crystallizability refers to a polymer having a melting point Mp. The polymer having a melting point Mp refers to a polymer whose melting point Mp can be observed with a differential scanning calorimeter (DSC). When a polymer having crystallizability is used, mechanical strength of the optical layered film can be increased particularly effectively, so that bend resistance can be remarkably improved. In addition, chemical resistance of the optical layered film can be improved.

The thermoplastic resin A particularly preferably contains an alicyclic structure-containing polymer having crystallizability. Examples of the alicyclic structure-containing polymer having crystallizability may include the following polymer (α) to polymer (δ). Among these, the polymer (β) is preferable as the alicyclic structure-containing polymer having crystallizability because the optical layered film having excellent heat resistance can be easily obtained therewith.

Polymer (α): a ring-opening polymer of a cyclic olefin monomer having crystallizability

Polymer (β): a hydrogenated product of the polymer (α) having crystallizability

Polymer (γ): an addition polymer of a cyclic olefin monomer having crystallizability

Polymer (δ): a hydrogenated product and the like of the polymer (γ) having crystallizability

Specifically, the alicyclic structure-containing polymer having crystallizability is more preferably a ring-opening polymer of dicyclopentadiene having crystallizability or a hydrogenated product of the ring-opening polymer of dicyclopentadiene having crystallizability. The alicyclic structure-containing polymer is particularly preferably a hydrogenated product of the ring-opening polymer of dicyclopentadiene having crystallizability. Herein, the ring-opening polymer of dicyclopentadiene refers to a polymer in which the ratio of a structural unit derived from dicyclopentadiene relative to all structural units is usually 50% by weight or more, preferably 70% by weight or more, more preferably 90% by weight or more, and further preferably 100% by weight.

The hydrogenated product of the ring-opening polymer of dicyclopentadiene preferably has a high ratio of the racemo diad. Specifically, the ratio of the racemo diad of the repeating unit in the hydrogenated product of ring-opening polymer of dicyclopentadiene is preferably 51% or more, more preferably 70% or more, and particularly preferably 85% or more. The increased ratio of the racemo diad represents the increased degree of syndiotactic stereoregularity thereof. The higher the ratio of the racemo diad is, the higher the melting point of the hydrogenated product of the ring-opening polymer of dicyclopentadiene tends to become.

The ratio of the racemo diad may be determined by ¹³C-NMR spectrum analysis to be described later in the examples.

The alicyclic structure-containing polymer having crystallizability does not have to be crystallized before the production of the optical layered film. However, after the optical layered film is produced, the alicyclic structure-containing polymer having crystallizability contained in the optical layered film can have a high crystallization degree because it is usually crystallized. The specific range of crystallization degree may be appropriately selected according to the desired performance, and is preferably 10% or more, more preferably 15% or more. When the crystallization degree of the alicyclic structure-containing polymer contained in the optical layered film is equal to or more than the lower limit value of the abovementioned range, chemical resistance can be imparted to the optical layered film. The crystallization degree may be measured by an X-ray diffraction method.

The abovementioned alicyclic structure-containing polymer having crystallizability may be produced by the method, for example, described in International Publication No. 2016/067893.

The weight-average molecular weight (Mw) of the polymer contained in the thermoplastic resin A is preferably 10,000 or more, more preferably 15,000 or more, and particularly preferably 20,000 or more, and is preferably 100,000 or less, more preferably 80,000 or less, and particularly preferably 50,000 or less. The polymer having such a weight-average molecular weight has excellent balance of mechanical strength, molding processability, and heat resistance.

The melting point Mp of the polymer having crystallizability, which may be contained in the thermoplastic resin A, is preferably 200° C. or higher, and more preferably 230° C. or higher, and is preferably 290° C. or lower. When the polymer having crystallizability and such a melting point Mp is used, an optical layered film having excellent balance of moldability and heat resistance can be obtained.

The glass transition temperature Tg of the polymer contained in the thermoplastic resin A is preferably 80° C. or higher, more preferably 85° C. or higher, and further preferably 90° C. or higher, and is preferably 250° C. or lower, and more preferably 170° C. or lower. A polymer having a glass transition temperature in such a range is less likely to be deformed and stressed when used at a high temperature, and has excellent heat resistance.

The molecular weight distribution (Mw/Mn) of the polymer contained in the thermoplastic resin A is preferably 1.2 or more, more preferably 1.5 or more, and particularly preferably 1.8 or more, and is preferably 3.5 or less, more preferably 3.4 or less, and particularly preferably 3.3 or less. When the molecular weight distribution is equal to or more than the lower limit value of the abovementioned range, productivity of the polymer can be increased and production costs can be suppressed. When the molecular weight distribution is equal to or less than the upper limit value, the amount of the low molecular weight component is small, so that relaxation at the time of high temperature exposure can be suppressed and the stability of the optical layered film can be improved.

The weight-average molecular weight Mw and the number-average molecular weight Mn of the polymer may be measured as a polyisoprene-equivalent value (or a polystyrene-equivalent value when toluene is used as a solvent) by gel permeation chromatography (hereinafter, abbreviated as “GPC”) using cyclohexane as a solvent (or using toluene when the resin is not dissolved in cyclohexane). Alternatively, the weight-average molecular weight Mw and the number-average molecular weight Mn of the polymer may be measured as a polystyrene-equivalent value by GPC using tetrahydrofuran as a solvent.

The ratio of the polymer in the thermoplastic resin A is preferably 80% by weight to 100% by weight, more preferably 90% by weight to 100% by weight, further preferably 95% by weight to 100% by weight, and particularly preferably 98% by weight to 100% by weight, from the viewpoint of obtaining an optical layered film excellent in, particularly, heat resistance and bend resistance.

The thermoplastic resin A may contain an optional component in combination with the above-mentioned polymer. Examples of the optional component may include an inorganic fine particle; a stabilizer such as an antioxidant, a heat stabilizer, an ultraviolet absorber, and a near-infrared absorber; a resin modifier such as a lubricant and a plasticizer; a colorant such as a dye and a pigment; and an antistatic agent. As the optional component, one type thereof may be solely used, and two or more types thereof may also be used in combination at any ratio. From the viewpoint of remarkably exerting the advantageous effects of the present invention, it is preferable that the content of the optional component is small. For example, the total ratio of the optional component is preferably 20 parts by weight or less, more preferably 15 parts by weight or less, further preferably 10 parts by weight or less, and particularly preferably 5 parts by weight or less, relative to 100 parts by weight of the polymer contained in the thermoplastic resin A. When the amount of the optional component contained in the thermoplastic resin A is small, bleeding out of the optional component can be suppressed.

(Thickness of a Layer)

The thickness of the A layer is preferably 3 μm or more, more preferably 5 μm or more, and further preferably 10 μm or more, and is preferably 50 μm or less, more preferably 30 μm or less, and further preferably 20 μm or less. When the thickness of the A layer is equal to or more than the lower limit value of the abovementioned range, properties such as bend resistance and chemical resistance of the optical layered film can be effectively improved by the action of the A layer. On the other hand, when the thickness of the A layer is equal to or less than the upper limit value of the abovementioned range, thinning of the optical layered film can be achieved.

[1.2. Layer B]

### (Thermoplastic Resin B)

The B layer is formed of the thermoplastic resin B. The thermoplastic resin B forming the B layer has a flexural modulus E₃ of usually 100 MPa or more and 900 MPa or less, preferably 100 MPa or more, more preferably 250 MPa or more, and further preferably 400 MPa or more, and of preferably 900 MPa or less, more preferably 800 MPa or less, and further preferably 700 MPa or less, when the thermoplastic resin B is formed as a film having a thickness of 4 mm. When the flexural modulus E_{B} is within the abovementioned range, rigidity and flexibility of the B layer are balanced, and the optical layered film has excellent bend resistance.

When the optical layered film contains two B layers, the thermoplastic resins B forming the two B layers may be the same resin or different resins. From the viewpoint of simplifying the production, the resins B are the same as each other.

As the thermoplastic resin B, a resin that contains a thermoplastic polymer and, as necessary, may contain an optional component can be used. As the polymer, one type thereof may be solely used, and two or more types thereof may also be used in combination at any ratio. Examples of the polymer that may be contained in the thermoplastic resin B may include those described as the polymer that may be contained in the thermoplastic resin A.

As the polymer that may be contained in the thermoplastic resin B, a hydrogenated product of a block copolymer of an aromatic vinyl compound and a conjugated diene compound and an alkoxysilyl group-modified product of the hydrogenated product are preferable.

The block copolymer of an aromatic vinyl compound and a conjugated diene compound includes a polymer block [A] containing an aromatic vinyl compound unit as a constitutional unit and a polymer block [B] containing a conjugated diene compound unit as a constitutional unit.

The aromatic vinyl compound unit refers to a structural unit having a structure formed by polymerizing an aromatic vinyl compound. However, the aromatic vinyl compound unit is not limited by the producing method. Examples of the aromatic vinyl compound corresponding to the aromatic vinyl compound unit that the polymer block [A] has may include styrene; styrenes having an alkyl group of 1 to 6 carbon atoms as a substituent such as α-methylstyrene, 2-methylstyrene, 3-methylstyrene, 4-methylstyrene, 2,4-dimethylstyrene, 2,4-diisopropylstyrene, 4-t-butylstyrene, and 5-t-butyl-2-methylstyrene; styrenes having a halogen atom as a substituent such as 4-chlorostyrene, dichlorostyrene, and 4-monofluorostyrene; styrenes having an alkoxy group of 1 to 6 carbon atoms as a substituent such as 4-methoxystyrene; styrenes having an aryl group as a substituent such as 4-phenylstyrene; and vinylnaphthalenes such as 1-vinylnaphthalene and 2-vinylnaphthalene. As these compounds, one type thereof may be solely used, and two or more types thereof may also be used in combination at any ratio. Among these, an aromatic vinyl compound containing no polar group, such as styrene or styrenes having an alkyl group of 1 to 6 carbon atoms as a substituent is preferable because hygroscopicity can be decreased. Styrene is particularly preferable because of its industrial availability.

The content ratio of the aromatic vinyl compound unit in the polymer block [A] is preferably 90% by weight or more, more preferably 95% by weight or more, and particularly preferably 99% by weight or more, and is usually 100% by weight or less. By increasing the amount of the aromatic vinyl compound unit in the polymer block [A] as described above, hardness and heat resistance of the B layer can be increased.

In addition to the aromatic vinyl compound unit, the polymer block [A] may contain an optional structural unit. The polymer block [A] may contain one type of optional structural unit solely or may contain two or more types thereof in combination at any ratio.

Examples of the optional structural unit that the polymer block [A] may contain may include a chain conjugated diene compound unit. In this specification, a conjugated diene compound unit refers to a structural unit having a structure formed by polymerizing a conjugated diene compound. However, the conjugated diene compound unit is not limited by the producing method. Examples of the conjugated diene compound corresponding to the conjugated diene compound unit may include the same examples as those mentioned as examples of the conjugated diene compound corresponding to the conjugated diene compound unit that the polymer block [B] contains.

Examples of the optional structural unit that the polymer block [A] may contain may include a structural unit having a structure formed by polymerizing an optional unsaturated compound other than an aromatic vinyl compound and the conjugated diene compound. Examples of the optional unsaturated compound may include a vinyl compound such as a chain vinyl compound and a cyclic vinyl compound; an unsaturated cyclic acid anhydride; and an unsaturated imide compound. These compounds may have a substituent such as a nitrile group, an alkoxycarbonyl group, a hydroxycarbonyl group, or a halogen group. Among these, from the viewpoint of hygroscopicity, a vinyl compound having no polar group such as a chain olefin of 2 to 20 carbon atoms per molecule such as ethylene, propylene, 1-butene, 1-pentene, 1-hexene, 1-heptene, 1-octene, 1-nonene, 1-decene, 1-dodecene, 1-eicosene, 4-methyl-1-pentene, and 4,6-dimethyl-1-heptene; a cyclic olefin of 5 to 20 carbon atoms per molecule such as vinylcyclohexane is preferable. A chain olefin of 2 to 20 carbon atoms per molecule is more preferable, and ethylene and propylene are particularly preferable.

The content ratio of the optional structural unit in the polymer block [A] is preferably 10% by weight or less, more preferably 5% by weight or less, and particularly preferably 1% by weight or less, and is usually 0% by weight or more, and may be 0% by weight.

The number of the polymer blocks [A] in one molecule of the block copolymer is preferably 2 or more, and is preferably 5 or less, more preferably 4 or less, and particularly preferably 3 or less. A plurality of polymer blocks [A] in one molecule may be the same as, or different from, each other.

When a plurality of different polymer blocks [A] are present in one molecule of the block copolymer, a weight-average molecular weight of the polymer block having the largest weight-average molecular weight among the polymer blocks [A] is defined as Mw(A1) and a weight-average molecular weight of the polymer block having the smallest weight-average molecular weight is defined as Mw(A2). At this time, the ratio “Mw(A1)/Mw(A2)” between Mw(A1) and Mw(A2) is preferably 4.0 or less, more preferably 3.0 or less, and particularly preferably 2.0 or less. As a result, variations in various property values can be suppressed to be small.

The polymer block [B] is a polymer block containing a conjugated diene compound unit.

Examples of the conjugated diene compound corresponding to the conjugated diene compound unit that this polymer block [B] has may include a chain conjugated diene compound (linear conjugated diene, branched conjugated diene) such as 1,3-butadiene, isoprene, 2,3-dimethyl-1,3-butadiene, and 1,3-pentadiene. As these compounds, one type thereof may be solely used, and two or more types thereof may also be used in combination at any ratio. Among these, a chain conjugated diene compound containing no polar group is preferable because of hygroscopicity can be reduced. 1,3-butadiene and isoprene are particularly preferable.

The content ratio of the conjugated diene compound unit in the polymer block [B] is preferably 70% by weight or more, more preferably 80% by weight or more, and particularly preferably 90% by weight or more, and is usually 100% by weight or less. By increasing the amount of the conjugated diene compound unit in the polymer block [B] as described above, flexibility of the B layer can be improved.

In addition to the conjugated diene compound unit, the polymer block [B] may contain an optional structural unit. The polymer block [B] may contain one type of optional structural unit solely or may contain two or more types thereof in combination at any ratio.

Examples of the optional structural unit that the polymer block [B] may contain may include an aromatic vinyl compound unit and a structural unit having a structure formed by polymerizing an optional unsaturated compound other than the aromatic vinyl compound and the conjugated diene compound. Examples of these aromatic vinyl compound unit and structural unit having a structure formed by polymerizing an optional unsaturated compound may include the same examples as those exemplified as those that may be contained in the polymer block [A].

The content ratio of the optional structural unit in the polymer block [B] is preferably 30% by weight or less, more preferably 20% by weight or less, and particularly preferably 10% by weight or less. By decreasing the content ratio of the optional structural unit in the polymer block [B], flexibility of the B layer can be improved.

The number of polymer blocks [B] in one molecule of the block copolymer is usually 1 or more, and may be 2 or more. When the number of polymer blocks [B] in the block copolymer is 2 or more, these polymer blocks [B] may be the same as, or different from, each other.

When a plurality of different polymer blocks [B] are present in one molecule of the block copolymer, a weight-average molecular weight of the polymer block having the largest weight-average molecular weight among the polymer blocks [B] is defined as Mw(B1), and a weight-average molecular weight of the polymer block having the smallest weight-average molecular weight is defined as Mw(B2). At this time, the ratio “Mw (B1)/Mw(B2)” of Mw (B1) and Mw (B2) is preferably 4.0 or less, more preferably 3.0 or less, and particularly preferably 2.0 or less. As a result, variations in various property values can be suppressed to be small.

The block form of the block copolymer may be a chain type block or a radial type block. Among these, a chain type block is preferable because of excellent mechanical strength. When the block copolymer has a form of a chain type block, it is preferable that both ends of the molecular chain of the block copolymer are the polymer block [A], since stickiness of the B layer can be suppressed to a desired low value.

The block copolymer preferably contains two or more polymer blocks [A] per one molecule of the block copolymer and one or more polymer blocks [B] per one molecule of the block copolymer.

A particularly preferable block form of the block copolymer is a triblock copolymer in which a polymer block [A] is bonded to both ends of a polymer block [B] as represented by [A]-[B]-[A]; or a pentablock copolymer in which polymer blocks [B] are bonded to both ends of a polymer block [A], and polymer blocks [A] are bonded to the other ends of both the polymer blocks [B], respectively, as represented by [A]-[B]-[A]-[B]-[A]. In particular, the triblock copolymer of [A]-[B]-[A] is particularly preferable because it can be easily produced and properties can be easily confined within desired ranges.

In the block copolymer, the ratio (wA/wB) of the weight fraction wA of the polymer block [A] in the entire block copolymer to the weight fraction wB of the polymer block [B] in the entire block copolymer is preferably confined within a certain range. Specifically, the ratio (wA/wB) is preferably 20/80 or more, more preferably 25/75 or more, further preferably 30/70 or more, and particularly preferably 40/60 or more, and is preferably 60/40 or less, and more preferably 55/45 or less. When the ratio wA/wB is equal to or more than the lower limit value of the abovementioned range, hardness and heat resistance of the B layer can be improved and its birefringence can be reduced. When the ratio wA/wB is equal to or less than the upper limit value of the abovementioned range, flexibility of the B layer can be improved. Herein, the weight fraction wA of the polymer block [A] indicates the weight fraction of the entire polymer block [A], and the weight fraction wB of the polymer block [B] indicates the weight fraction of the entire polymer block [B].

The weight-average molecular weight (Mw) of the block copolymer is preferably 40,000 or more, more preferably 50,000 or more, and particularly preferably 60,000 or more, and is preferably 200,000 or less, more preferably 150,000 or less, and particularly preferably 100,000 or less.

The molecular weight distribution (Mw/Mn) of the block copolymer is preferably 3 or less, more preferably 2 or less, and particularly preferably 1.5 or less, and is preferably 1.0 or more. Herein, Mn represents a number-average molecular weight.

The weight-average molecular weight (Mw) and molecular weight distribution (Mw/Mn) of the block copolymer may be measured as a polystyrene-equivalent value by gel permeation chromatography (GPC) using tetrahydrofuran (THF) as a solvent.

The hydrogenated product of the block copolymer is a polymer obtained by hydrogenating an unsaturated bond of a block copolymer. Herein, the unsaturated bonds of the block copolymer to be hydrogenated include both the carbon-carbon unsaturated bonds of the main chain and the side chain of the block copolymer and the carbon-carbon unsaturated bond of the aromatic ring.

The hydrogenation rate is preferably 90% or more, more preferably 97% or more, and particularly preferably 99% or more, and is usually 100% or less, and may be 100%, of the carbon-carbon unsaturated bonds of the main chain and the side chain and the carbon-carbon unsaturated bond of the aromatic ring of the block copolymer. The higher the hydrogenation rate is, the better the transparency, heat resistance, and weather resistance of the B layer are. Herein, the hydrogenation rate of the hydrogenated product may be determined by measuring ¹H-NMR.

In particular, the hydrogenation rate of the carbon-carbon unsaturated bonds of the main chain and the side chain is preferably 95% or more, and more preferably 99% or more. By increasing the hydrogenation rate of the carbon-carbon unsaturated bonds of the main chain and the side chain, light resistance and oxidation resistance of the B layer can be further increased.

Further, the hydrogenation rate of the carbon-carbon unsaturated bond of the aromatic ring is preferably 90% or more, more preferably 93% or more, and particularly preferably 95% or more. By increasing the hydrogenation rate of the carbon-carbon unsaturated bond of the aromatic ring, the glass transition temperature of the polymer block obtained by hydrogenating the polymer block [A] increases, so that heat resistance of the B layer can be effectively increased.

The weight-average molecular weight (Mw) of the hydrogenated product of the block copolymer is usually 35,000 or more and 250,000 or less, preferably 35,000 or more, more preferably 40,000 or more, further preferably 50,000 or more, and particularly preferably 60,000 or more, and is preferably 250,000 or less, more preferably 200,000 or less, further preferably 150,000 or less, and particularly preferably 100,000 or less. When the weight-average molecular weight (Mw) of the hydrogenated product is within the abovementioned range, mechanical strength and heat resistance of the B layer can be improved.

The molecular weight distribution (Mw/Mn) of the hydrogenated product of the block copolymer is preferably 3 or less, more preferably 2 or less, and particularly preferably 1.5 or less, and is preferably 1.0 or more. When the molecular weight distribution (Mw/Mn) of the hydrogenated product is within the abovementioned range, mechanical strength and heat resistance of the B layer can be improved.

The weight-average molecular weight (Mw) and the molecular weight distribution (Mw/Mn) of the hydrogenated product of the block copolymer may be measured as a polystyrene-equivalent value by gel permeation chromatography (GPC) using tetrahydrofuran as a solvent.

As a method for producing a block copolymer and a hydrogenated product of a block copolymer, for example, a method described in International Publication No. 2014/077267 may be used.

An alkoxysilyl group-modified product of a hydrogenated product of a block copolymer is a polymer obtained by introducing an alkoxysilyl group into the hydrogenated product of the block copolymer described above. In this case, the alkoxysilyl group may be directly bonded to the abovementioned hydrogenated product, and may be indirectly bonded thereto via a divalent organic group such as an alkylene group, for example. An alkoxysilyl group-modified product into which an alkoxysilyl group has been introduced is particularly excellent in adhesion to an inorganic material such as glass or metal. Therefore, the B layer may be formed as a layer having the excellent adhesion to inorganic materials described above.

The introduced amount of the alkoxysilyl group in the alkoxysilyl group-modified product is preferably 0.1 part by weight or more, more preferably 0.2 part by weight or more, and particularly preferably 0.3 part by weight or more, and is preferably 10 parts by weight or less, more preferably 5 parts by weight or less, and particularly preferably 3 parts by weight or less, relative to 100 parts by weight of the hydrogenated product before introduction of the alkoxysilyl group. When the introduced amount of the alkoxysilyl group is within the abovementioned range, the degree of crosslinking between the alkoxysilyl groups decomposed by moisture or the like can be prevented from becoming excessively high, so that high adhesiveness of the B layer to inorganic materials can be maintained.

The introduced amount of the alkoxysilyl group may be measured by ¹H-NMR spectrum. When the introduced amount of the alkoxysilyl group is small, the introduced amount of the alkoxysilyl group can be measured by increasing the number of times of integration.

The alkoxysilyl group-modified product may be produced by introducing the alkoxysilyl group into the hydrogenated product of the block copolymer described above. Examples of the method for introducing the alkoxysilyl group into the hydrogenated product may include a method for reacting the hydrogenated product with an ethylenically unsaturated silane compound in the presence of a peroxide, and specifically, a method described in International Publication No. 2014/077267 may be used.

As the ethylenically unsaturated silane compound, one which can be graft-polymerized with the hydrogenated product and can introduce an alkoxysilyl group into the hydrogenated product may be used. Examples of such an ethylenically unsaturated silane compound may include an alkoxysilane having a vinyl group such as vinyltrimethoxysilane, vinyltriethoxysilane, dimethoxymethylvinylsilane, and diethoxymethylvinylsilane; an alkoxysilane having an allyl group such as allyltrimethoxysilane and allyltriethoxysilane; an alkoxysilane having a p-styryl group such as p-styryltrimethoxysilane and p-styryltriethoxysilane; an alkoxysilane having a 3-methacryloxypropyl group such as 3-methacryloxypropyltrimethoxysilane, 3-methacryloxypropylmethyldimethoxysilane, 3-methacryloxypropyltriethoxysilane, and 3-methacryloxypropylmethyldiethoxysilane; an alkoxysilane having a 3-acryloxypropyl group such as 3-acryloxypropyltrimethoxysilane and 3-acryloxypropyltriethoxysilane; and an alkoxysilane having a 2-norbornen-5-yl group such as 2-norbornen-5-yltrimethoxysilane. Among these, since the advantageous effects of the present invention are more easily obtained, vinyltrimethoxysilane, vinyltriethoxysilane, dimethoxymethylvinylsilane, diethoxymethylvinylsilane, allyltrimethoxysilane, allyltriethoxysilane, and p-styryltrimethoxysilane are preferable. As the ethylenically unsaturated silane compound, one type thereof may be solely used, and two or more types thereof may also be used in combination at any ratio.

The amount of the ethylenically unsaturated silane compound is preferably 0.1 part by weight or more, more preferably 0.2 part by weight or more, and particularly preferably 0.3 part by weight or more, and is preferably 10 parts by weight or less, more preferably 5 parts by weight or less, and particularly preferably 3 parts by weight or less, relative to 100 parts by weight of the hydrogenated product before the introduction of the alkoxysilyl group.

In the thermoplastic resin B, the total ratio of the hydrogenated product of the abovementioned block polymer and the alkoxysilyl group-modified product of the hydrogenated product is preferably 80% by weight to 100% by weight, more preferably 90% by weight to 100% by weight, and particularly preferably 95% by weight to 100% by weight.

The thermoplastic resin B may contain an optional component in combination with the abovementioned polymer. Examples of the optional components may include the same examples as those of the optional components that the thermoplastic resin A may contain.

(Thickness of B Layer)

The thickness of the B layer is preferably 1 μm or more, more preferably 5 μm or more, and further preferably 10 μm or more, and is preferably 50 μm or less, more preferably 40 μm or less, and further preferably 30 μm or less. When the thickness of the B layer is equal to or more than the lower limit value of the abovementioned range, the bend resistance of the optical layered film can be effectively improved by the action of the B layer. On the other hand, when the thickness of the B layer is equal to or less than the upper limit value of the abovementioned range, thinning of the optical layered film can be achieved.

When the optical layered film includes two B layers, each of the two B layers may have the same thickness or different thicknesses, and from the viewpoint of suppressing curling of the optical layered film, it is preferable that the two B layers have the same thickness.

[1.3. Ratio of Thicknesses of B Layer and A Layer]

The ratio (B/A) of the thickness of the B layer to the thickness of the A layer is preferably 1/10 or more, more preferably 1/5 or more, and further preferably 1/3 or more, and is preferably 1/1 or less, more preferably 1/1.2 or less, and further preferably 1/1.3 or less. Herein, when the optical layered film includes two B layers, the preferable ratio is a ratio of the thickness of one B layer to the thickness of the A layer.

When the ratio of the thickness of the B layer to the thickness of the A layer is within the aforementioned range, bend resistance of the optical layered film can be effectively improved.

[1.4. Optional Layer]

The optical layered film may include an optional layer in addition to the A layer and the B layer, as necessary. Examples of the optional layer may include a functional layer such as an index matching layer, a hard coat layer, and a tackiness agent (adhesive) layer.

[1.5. Properties and the Like of Optical Layered Film]

### (Thickness of Optical Layered Film)

The optical layered film may have any thickness depending on the intended use. The thickness of the optical layered film is preferably 3 μm or more, more preferably 10 μm or more, and further preferably 20 μm or more, and is preferably 150 μm or less, more preferably 100 μm or less, and further preferably 60 μm or less. Herein, when the optical layered film has two B layers, the thickness of the optical layered film is the total thickness of the optical layered film including the A layer and two B layers. When the thickness of the optical layered film is equal to or more than the abovementioned lower limit value, mechanical strength of the optical layered film can be increased. When the thickness is equal to or less than the abovementioned upper limit value, thinning of the optical layered film can be achieved.

(Tear Strength)

The optical layered film of the present embodiment having the aforementioned configuration has high tear strength. Specifically, the tear strength of the optical layered film is preferably 1.30 N/mm or more, more preferably 1.4 N/mm or more, and further preferably 1.5 N/mm or more. Although the higher tear strength is more preferable, it can be set to 5 N/mm or less.

The tear strength (N/mm) may be obtained by the following method. First, a test piece having dimensions of 150 mm in length and 50 mm in width and having a 75 mm long slit parallel to the lengthwise direction at the center position in the width direction was prepared. Then, two end portions of the test piece divided by the slit are gripped and pulled by a tensile testing machine to tear the test piece. Next, an average value Ft(N) of the tearing force between a tear length of 20 mm and a tear length of 70 mm is obtained, and the average value Ft is divided by the thickness d (mm) of the test piece to obtain the tear strength (N/mm) of the test piece.

The tear strength of the optical layered film may be an average value of the tear strength obtained from two test pieces.

(Chemical Resistance)

The optical layered film of the present embodiment having the aforementioned configuration has excellent chemical resistance. Specifically, the chemical resistance of the optical layered film may be evaluated by immersing the bent optical layered film in cyclohexane or sulfuric acid with 30%. concentration at room temperature (25° C.) for 48 hours and then examining the absence of cracks in the optical layered film and rupture of the optical layered film by visual observation or under an optical microscope.

[1.6. Configuration Example of Optical Layered Film]

A description will be given of configuration examples of the optical layered film with reference to the drawings. The present invention is not limited by these configuration examples, and may include other components as necessary.

### Embodiment F-1 of Optical Layered Film

In an embodiment F-1 of the optical layered film, the B layer is provided on one surface of the A layer.

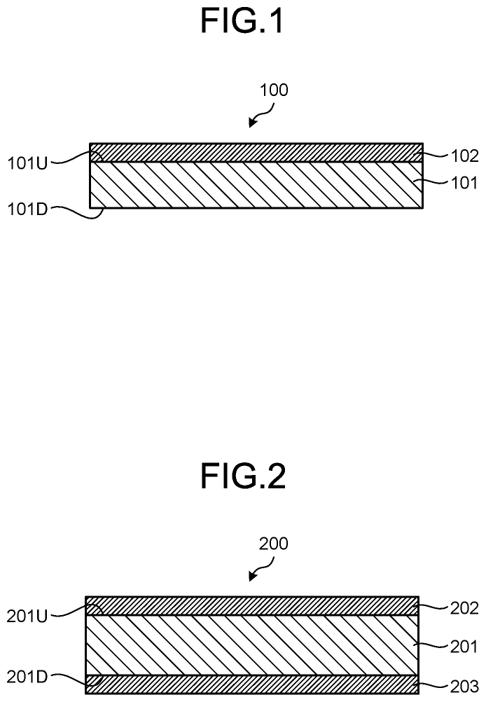

FIG. 1 is a cross-sectional view schematically illustrating the embodiment F-1 of the optical layered film.

As illustrated in FIG. 1, an optical layered film 100 includes an A layer 101 and a B layer 102. The A layer 101 has a surface 101U and a surface 101D, and the B layer 102 is provided directly on one surface 101U of the A layer 101.

The optical layered film of the present embodiment has excellent bend resistance at least when tensile stress is applied to the B layer 102.

### Embodiment F-2 of Optical Layered Film

In an embodiment F-2 of the optical layered film, the optical layered film includes two B layers, which are provided on respective sides of the A layer.

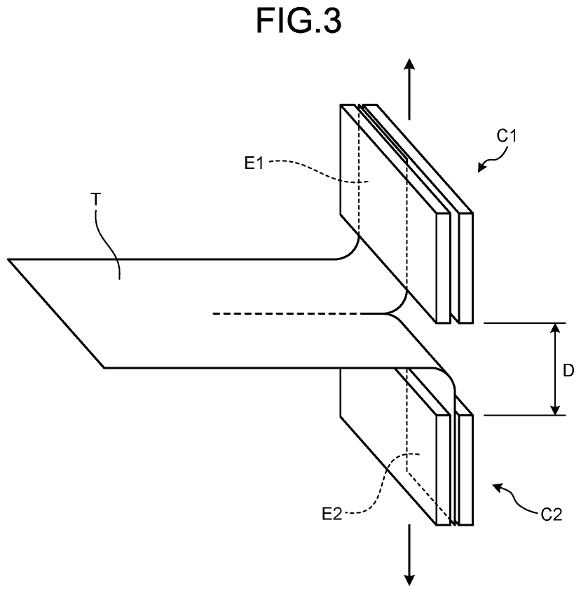

FIG. 2 is a cross-sectional view schematically illustrating the embodiment F-2 of the optical layered film.

As illustrated in FIG. 2, the optical layered film 200 includes a first B layer 202, an A layer 201, and a second B layer 203 in this order. The first B layer 202 is directly provided on the surface 201U of the A layer 201, and the second B layer 203 is directly provided on the surface 201D of the A layer 201.

The optical layered film of the present embodiment has excellent bend resistance both when tensile stress is applied to the first B layer 202 and when tensile stress is applied to the second B layer 203.

[1.7. Method for Producing Optical Layered Film]

The optical layered film can be produced by an optional method. Examples of the producing method may include a method for separately forming and layering the A layer and the B layer, and a method for simultaneously producing the A layer and the B layer by a method such as a coextrusion method, a co-casting method, or the like to obtain an optical layered film.

Examples of the method for forming the A layer or the B layer may include a melt extrusion method, and a method including applying a solution containing a material of the A layer or B layer and a solvent onto a supporting film, of which surface has been subjected to a releasing treatment, to form a coating layer, and removing the solvent from the coating layer to obtain the A layer or B layer having the supporting film.

Examples of the method for layering the separately formed A layer and B layer may include a method for pressing and bonding the A layer and the B layer while heating, and a method for bonding the A layer and the B layer via the tackiness agent layer.

When the A layer and the B layer are layered, the surface of the A layer or the B layer may be subjected to a surface treatment such as a corona treatment.

When a layered film is produced from the A layer or the B layer having the supporting film, the supporting film may be removed before layering the A layer and the B layer. Alternatively, after the A layer or B layer having the supporting film is layered as it is to obtain the layered body, the supporting film may be removed from the layered body to obtain the optical layered film.

The optical layered film may be a film obtained by producing a layered body including the A layer and the B layer, and then annealing the layered body. The temperature condition of the annealing treatment may be, for example, 90° C. or higher and 270° C. or lower. The annealing treatment time may be, for example, 1 second or longer and 180 seconds or shorter. The annealed optical layered film has improved tear strength and excellent chemical resistance. The reason for this is considered to be that crystallization of a polymer that may be contained in the optical layered film is promoted, but the present invention is not limited by the reason.

[1.8. Use Application of Optical Layered Film]

A use application of the optical layered film is not particularly limited. The optical layered film having excellent bend resistance can be suitably used, for examples, as a protective film of an optical member that may be repeatedly bent and a film for forming an electroconductive film constituting a touch panel.

[2. Electroconductive Film]

The electroconductive film according to one embodiment of the present invention includes the aforementioned optical layered film and an electroconductive layer. The electroconductive film including the aforementioned optical layered film having excellent bend resistance may also be formed as a film having excellent bend resistance.

The electroconductive layer is a layer having electroconductivity. The layer having electroconductivity is normally formed as a layer including a material having electroconductivity (electroconductive material). Examples of the electroconductive material may include metal, an electroconductive metal oxide, an electroconductive nanowire, and an electroconductive polymer. Further, as the electroconductive material, one type thereof may be solely used, and two or more types thereof may also be used in combination at any ratio.

The electroconductive layer may be formed by a method such as a method for applying a coating liquid including the electroconductive material; a vapor deposition method; and a sputtering method.

The electroconductive film may include the optical layered film in which the B layer is disposed only on one surface of the A layer, such as the optical layered film according to the aforementioned embodiment F-1, or the optical layered film in which the B layers are disposed on both surfaces of the A layer, such as the optical layered film according to the aforementioned embodiment F-2.

Examples of the layer configuration of the electroconductive film may include the following configurations.

(1) An electroconductive film including an electroconductive layer, the B layer, and the A layer in this order.
(2) An electroconductive film including an electroconductive layer, the A layer, and the B layer in this order.
(3) An electroconductive film including an electroconductive layer, the B layer, the A layer, and the B layer in this order.
(4) An electroconductive film including an electroconductive layer, the B layer, the A layer, the B layer, and an electroconductive layer in this order.

The electroconductive layer may be formed on the entire surface of the layer where the electroconductive layer is formed or on a part of the surface of the layer where the electroconductive layer is formed. For example, the electroconductive layer may be formed on a part of the surface of the resin layer in a manner of being patterned in a specific pattern. The pattern shape of the electroconductive layer may be set in accordance with the use application of the electroconductive film. For example, when the electroconductive film is used as a circuit board, a planar shape of the electroconductive layer may be formed in a pattern corresponding to a wiring shape of the circuit. Further, for example, when the electroconductive film is used as a sensor film for a touch panel, a planar shape of the electroconductive layer is preferably formed in a pattern that allows a satisfactory operation of a touch panel (for example, a capacitive type touch panel).

### EXAMPLES

Hereinafter, the present invention will be specifically described by illustrating examples. However, the present invention is not limited to the following examples, and may be freely modified for implementation without departing from the scope of claims of the present invention and the scope of their equivalents.

In the following description, “%” and “part” representing quantity are on the basis of weight, unless otherwise specified. The operations described below were performed under the conditions of normal temperature and normal pressure, unless otherwise specified.

[Evaluation Methods]

### (Measuring Method of Molecular Weight)

The weight-average molecular weight and the number average molecular weight of the polymer were measured as standard polystyrene-equivalent values by gel permeation chromatography using tetrahydrofuran as an eluent at 38° C. (the ring-opening polymer of dicyclopentadiene and the hydrogenated product thereof) or 40° C. (the hydrogenated product of the block copolymer). As the measurement device, HLC8320GPC manufactured by Tosoh Corp. was used.

(Measurement of Glass Transition Temperature and Melting Point)

The glass transition temperature Tg and the melting point Mp of the sample were obtained by using a differential scanning calorimetry (DSC) at a temperature rising rate of 10° C./min.

(Measuring Method of Ratio of Racemo Diads of Polymer)

The ¹³C-NMR measurement of the polymer was performed using ortho-dichlorobenzene-d⁴/trichlorobenzene-d³ (mixing ratio (weight basis) being 1/2) as a solvent at 200° C. by employing the inverse-gated decoupling method. In the ¹³C-NMR measurement result, a signal at 43.35 ppm derived from the meso diad and a signal at 43.43 ppm derived from the racemo diad were identified with the peak at 127.5 ppm of ortho-dichlorobenzene-d⁴ as a reference shift. The ratio of the racemo diad of the polymer was determined on the basis of the strength ratio of these signals.

(Measuring Method of Hydrogenation Rate of Polymer)

The hydrogenation rate of the polymer was measured by the ¹H-NMR measurement at 145° C. using ortho-dichlorobenzene-d₄ as a solvent.

(Measuring Method of Thickness)

The total thickness of the optical layered film was measured by a snap gage (manufactured by Mitutoyo Corp.). The thickness of the optical layered film was obtained as an average value calculated by measuring the thicknesses of the optical layered film at randomly selected 4 positions.

Further, the optical layered film was sliced using a microtome to obtain a slice having a thickness of 0.05 μm. Then, the cross section of the slice obtained by slicing was observed using an optical microscope to measure the respective thicknesses of the A layer and the B layer.

(Measuring Method of Flexural Modulus)

A sheet-shaped film having a thickness of 4 mm was obtained from the resin as a sample by the method described in Production Example described below. The obtained film was annealed in an oven at 170° C. for 30 seconds, and then the flexural modulus of the film was measured at a temperature of 23° C. in accordance with JIS K7171. As the measurement device, a tensile testing machine (“model 5564” manufactured by Instron Corp.) was used.

(Measuring Method of Tear Strength)

The tear strength of the optical layered film was measured by the following method.

Two test pieces, one of which has dimensions of 150 mm in length and 50 mm in width and has the machine direction (MD) during the molding of the film as a lengthwise direction, and the other of which has dimensions of 150 mm in length and 50 mm in width and has the machine direction of the film as a width direction, were cut out from the optical layered film.

In each of these two test pieces, a slit parallel to the lengthwise direction of the test piece was formed at the center position in the width direction of the test piece. The slit had a length from the end of the test piece of 75 mm.

Next, two test pieces thus obtained were subjected to the tear test with the tensile testing machine. The tear test will be described below by referring to the drawing.

FIG. 3 is an explanatory diagram explaining the tear test using the tensile testing machine.

One end portion E1 of a test piece T divided by the slit was gripped by an upper chuck C1 of the tensile testing machine (“FSA series” manufactured by IMADA Co., Ltd.) and the other end portion E2 was gripped by a lower chuck C2 of the tensile testing machine. A distance D between the upper chuck C1 and the lower chuck C2 was set to 75 mm.

A test speed of the tensile testing machine was set to 200 mm/min and the test piece thus gripped was pulled to measure the tear strength. After the measurement, a thickness d (mm) of the torn test piece was measured by using a snap gage.

An average value Ft(N) of the tearing force between the tear length of 20 mm and the tear length of 70 mm with the exclusion of the tear start site (tear length of 0 mm) to the tear length of 20 mm and the tear length of 70 mm to the tear end site (tear length of 75 mm) was obtained, and the tear strength of the test piece was determined by the following formula.

Tear strength of test piece (N/mm)=Ft/d

An average value of the tear strength obtained from two test pieces was used as a value of the tear strength of the optical layered film.

(Measuring Method of Tensile Break Elongation)

A sheet-shaped film having a thickness of 1.5 mm was formed of the resin as a sample by the method described in Production Example below. The obtained film was annealed in an oven at 170° C. for 30 seconds, and then the tensile break elongation of the film was measured by the following method in accordance with JIS K7127. First, a test piece having a dumbbell type 1B shape was punched from the film to be measured to prepare a measurement sample. As the measurement samples, a total of ten pieces were punched from the film: five pieces were punched along the machine direction (MD) of the film that had been melt-extruded or injection-molded and five pieces were punched along the transverse direction (TD) of the film perpendicular to the machine direction. As the measurement device, a tensile testing machine equipped with a constant-temperature and constant-humidity chamber (“Model 5564” manufactured by Instron Corp.) was used. A tensile speed was set to 20 mm/min for measurement. An average value of the tensile break elongation of the test pieces (N=5) punched along the machine direction and the test pieces (N=5) punched along the transverse direction was used as the tensile break elongation (v) of the film.

(Bend Resistance Test Method) The bend resistance test of the optical layered film was performed by the method of the tension-free U-shaped bending test for planar object using a table-top model endurance test machine (“DLDMLH-FS” manufactured by YUASA SYSTEM Co., Ltd.). Bending was performed repeatedly with the B layer being outside (a side applied with tensile stress) under conditions of a bending width of 50 mm, a bend radius of 2 mm, and a bending speed of 80 times/min. First, the device was stopped after the first bending operation and the optical layered film was visually observed. The optical layered film with a bending mark was evaluated as “lined”, while the optical layered film with no bending mark was evaluated as “no line”.

Next, the device was stopped and the optical layered film was visually observed in every 1,000 times when the bending number exceeds 1,000 until reaching 10,000, in every 5,000 times when the bending number exceeds 10,000 until reaching 50,000, and in every 10,000 times when the bending number exceeds 50,000. The optical layered film in which even a slight crack was confirmed was evaluated as “cracked”, while the optical layered film with no crack was evaluated as “no crack”. Evaluation was performed 4 times in Example 3 and Comparative examples with the bending number of 100,000 as an upper limit and in Examples 1, 2, 4, 5, and 6 with the bending number of 200,000 as an upper limit. Among 4 times of evaluation, a result with the highest bending number until the “crack” occurred was adopted as the evaluation result. When the crack did not occur in all 4 time, the film was evaluated as “no crack”.

(Chemical Resistance Test)

The optical layered film was subjected to the chemical resistance test by the following method.

The optical layered film was cut to have dimensions of 50 mm in length and 20 mm in width to obtain a rectangular test piece. The test piece was bent such that both short sides thereof were overlapped, and the overlapped end portions of the test piece were gripped by a clip having a width of the grip portion of 25 mm.

The bent portion of the test piece gripped by the clip was immersed in a test liquid put into a petri dish, and, after being taken out of the petri dish, the test piece was left standing at room temperature (25° C.) for 48 hours. Subsequently, the test piece was visually observed to confirm the presence/absence of cracks and rupture.

As the test liquid, cyclohexane or sulfuric acid with 30% concentration was used. In a case where cracks or rupture occurred in the test piece in the test using either of the test liquids, the film was evaluated as “changed”, while in a case where cracks or rupture did not occur in the test piece in the test using any of the test liquids, the film was evaluated as “no change”.

### Production Example 1: Production of Crystallizable COP Resin (a1) Including Hydrogenated Product of Ring-Opening Polymer of Dicyclopentadiene

A pressure-resistant reaction vessel formed of metal was sufficiently dried and then the atmosphere in the vessel was replaced with nitrogen. In this pressure-resistant reaction vessel, 154.5 parts of cyclohexane, 42.8 parts of a cyclohexane solution containing dicyclopentadiene (endo isomer content of 99% or more) in a concentration of 70% (30 parts as an amount of dicyclopentadiene), and 1.9 parts of 1-hexene were added, and the mixture was warmed to 53° C.

0.014 part of a tetrachlorotungsten phenylimide (tetrahydrofuran) complex was dissolved into 0.70 part of toluene to prepare a solution. Into this solution, 0.061 part of an n-hexane solution containing diethylaluminum ethoxide in a concentration of 19% were added. The mixture was stirred for 10 minutes to prepare a catalyst solution.

This catalyst solution was added into the pressure-resistant reaction vessel to initiate a ring-opening polymerization reaction. After that, the reaction was performed for 4 hours while being kept at 53° C. to obtain a solution of a ring-opening polymer of dicyclopentadiene.

The number-average molecular weight (Mn) and the weight-average molecular weight (Mw) of the obtained ring-opening polymer of dicyclopentadiene were 8,750 and 28,100, respectively. The molecular weight distribution (Mw/Mn) calculated from these was 3.21.

Into 200 parts of the obtained solution of the ring-opening polymer of dicyclopentadiene, 0.037 part of 1,2-ethanediol as a terminator was added. The mixture was warmed to 60° C. and stirred for 1 hour to terminate the polymerization reaction. To the resulting product, 1 part of a hydrotalcite-like compound (“Kyoward (registered trademark) 2000” manufactured by Kyowa Chemical Industry Co., Ltd.) was added. The mixture was warmed to 60° C. and stirred for 1 hour. After that, to the obtained product, 0.4 parts of a filter aid (“Radiolite (registered trademark) #1500” manufactured by Showa Chemical Industry Co., Ltd.) was added. The mixture was filtered through a PP pleated cartridge filter (“TCP-HX” manufactured by Advantec Toyo Kaisha Ltd.) to separate the adsorbent and the solution.

Into 200 parts (30 parts in terms of the polymer amount) of the filtered solution of the ring-opening polymer of dicyclopentadiene, 100 parts of cyclohexane and then 0.0043 part of chlorohydridocarbonyltris(triphenylphosphine)ruthenium were added to perform a hydrogenation reaction at a hydrogen pressure of 6 MPa and 180° C. for 4 hours. In this manner, a reaction liquid containing a hydrogenated product of the ring-opening polymer of dicyclopentadiene was obtained. This reaction liquid was obtained as a slurry solution in which the hydrogenated product was deposited.

The hydrogenated product and the solution included in the aforementioned reaction liquid were separated using a centrifugal separator, and the hydrogenated product was dried under reduced pressure at 60° C. for 24 hours to obtain 28.5 parts of the hydrogenated product of the ring-opening polymer of dicyclopentadiene having crystallizability. This hydrogenated product had a hydrogenation rate of 99% or more, a glass transition temperature Tg of 93° C., a melting point Mp of 262° C., and a racemo diad ratio of 89%.

To 100 parts of the hydrogenated product of the ring-opening polymer of dicyclopentadiene thus obtained, 1.1 parts of an antioxidant (tetrakis[methylene-3-(3′,5′-di-t-butyl-4′-hydroxyphenyl)propionate]methane; “Irganox (registered trademark) 1010” manufactured by BASF Japan Ltd.) was mixed, and then the mixture was charged into a twin-screw extruder equipped with four die holes each having an inner diameter of 3 mmΦ (“TEM-37B” manufactured by Toshiba Machine Co. Ltd.). The resin was molded in a strand shape by hot melt extrusion molding using the twin-screw extruder and then finely cut with a strand cutter to obtain pellets of the resin (crystallizable COP resin) (a1) including the alicyclic structure-containing polymer having crystallizability. This crystallizable COP resin (a1) is a resin including the hydrogenated product of the ring-opening polymer of dicyclopentadiene as the alicyclic structure-containing polymer having crystallizability.

The operation conditions of the aforementioned twin-screw extruder were as follows.
Barrel set temperature=270° C. to 280° C.
Die set temperature=250° C.
Screw rotation speed=145 rpm
Feeder rotation speed=50 rpm

A film having a thickness of 4 mm and a film having a thickness of 1.5 mm were obtained from the crystallizable COP resin (a1) by injection molding and subjected to measurement of the flexural modulus and the tensile break elongation by the aforementioned methods.

### Production Example 2: Production of Hydrogenated Product (B1) of Triblock Copolymer

With reference to the method described in International Publication No. 2014/077267, 25 parts of styrene, 50 parts of isoprene, and 25 parts of styrene were polymerized in this order to produce a hydrogenated product (b1) (weight-average molecular weight Mw=48,400; molecular weight distribution Mw/Mn=1.02; hydrogenation rate of carbon-carbon unsaturated bonds in main chains, side chains, and aromatic rings of almost 100%) of a triblock copolymer.

A film having a thickness of 4 mm was obtained from the hydrogenated product (b1) of the triblock copolymer by injection molding and subjected to measurement of the flexural modulus by the aforementioned method.

### Production Example 3: Production of Alkoxysilyl Group-Modified Product (b1-s) of Hydrogenated Product of Triblock Copolymer

With reference to the method described in International Publication No. 2014/077267 described above, 2 parts of vinyltrimethoxysilane was bonded to 100 parts of the hydrogenated product (b1) of the triblock copolymer produced in Production Example 2 to produce pellets of an alkoxysilyl group-modified product (b1-s) of the hydrogenated product of the triblock copolymer.

A film having a thickness of 4 mm was obtained from this alkoxysilyl group-modified product (b1-s) by injection molding and subjected to measurement of the flexural modulus by the aforementioned method.

### Production Example 4: Production of Resin (b2) Including Alkoxysilyl Group-Modified Product (b1-s)

Using the twin-screw extruder equipped with four die holes each having an inner diameter of 3 mmΦ (“TEM-37B” manufactured by Toshiba Machine Co. Ltd.), 28 parts by weight of the pellets of the alkoxysilyl group-modified product (b1-s) of the hydrogenated product of the triblock copolymer obtained in Production Example 3 and 12 parts by weight of hydrogenated polybutene (“PARLEAM (registered trademark) 24” manufactured by NOF Corp.) were kneaded at a resin temperature of 200° C. and extruded in a strand shape. After cooling in the air, the extruded product was cut with a pelletizer to obtain a resin (b2) in a pellet form.

A film having a thickness of 4 mm was obtained from the resin (b2) by injection molding and subjected to measurement of the flexural modulus by the aforementioned method.

### Production Example 5: Production Method of Polyester Terephthalate (PET) Resin Sample

A PET film (“COSMOSHINE” manufactured by TOYOBO Co., Ltd.) was crushed into a fluff (fragment) form. The PET resin (a2) in the fluff form thus obtained was melt-extruded to obtain films of the PET resin (a2) having a thickness of 4 mm and a thickness of 1.5 mm, and they were subjected to measurement of the flexural modulus and the tensile break elongation by the aforementioned methods.

### Production Example 6: Production of Tackiness Agent (c1) Layer

A monomer mixture was obtained by mixing 67 parts by weight of butyl acrylate, 14 parts by weight of cyclohexyl acrylate, 27 parts by weight of 4-hydroxybutyl acrylate, 9 parts by weight of hydroxyethyl acrylate, 0.05 part by weight of a photopolymerization initiator (“Irgacure 651” manufactured by BASF SE), and 0.05 part by weight of a photopolymerization initiator (“Irgacure 184” manufactured by BASF SE). This monomer mixture was partially photopolymerized by exposure to ultraviolet rays under a nitrogen atmosphere to obtain a partially polymerized product (acrylic polymer syrup) having a polymerization rate of about 10% by weight. To 100 parts by weight of the partially polymerized product thus obtained, 0.15 part by weight of dipentaerythritol hexaacrylate (“KAYARAD DPHA” manufactured by Nippon Kayaku Co., Ltd.) and 0.3 part by weight of a silane coupling agent (“KBM-403”, manufactured by Shin-Etsu Chemical Co., Ltd.) were added, and the mixture was uniformly mixed to obtain an acrylic tackiness agent composition.

The aforementioned acrylic tackiness agent composition was applied onto a release-treated surface of a release film (“DIAFOIL MRF #38” manufactured by Mitsubishi Plastics, Inc.) such that the thickness thereof after formation of the tackiness agent layer became 4 mm or 10 m, thereby forming tackiness agent composition layers. Next, a release film (“DIAFOIL MRF #38” manufactured by Mitsubishi Plastics, Inc.) was applied onto the surface of this tackiness agent composition layer such that a release-treated surface of this release film faces the tackiness agent composition layer. In this manner, the tackiness agent composition layer was blocked from oxygen.

Subsequently, the tackiness agent composition layer was subjected to ultraviolet ray irradiation under conditions of an illuminance of 5 mW/cm² and a light intensity of 1,500 mJ/cm² for photo-curing the tackiness agent composition layer, thereby obtaining a tackiness sheet having a layer configuration of release film/tackiness agent (c1) layer/release film. The weight-average molecular weight (Mw) of the acrylic polymer as a base polymer of the tackiness agent layer was 2,000,000. The tackiness sheet including the tackiness agent (c1) layer having a thickness of 10 μm was used for producing the optical layered film of Comparative Example 3 described below.

The release films were peeled off from the tackiness sheet including the tackiness agent layer having a thickness of 4 mm to obtain a tackiness agent layer having a thickness of 4 mm. The flexural modulus of the tackiness agent layer having a thickness of 4 mm thus obtained was measured by the aforementioned method.

### Example 1

The crystallizable COP resin (a1) obtained in Production example 1 was supplied to a T die at an extrusion screw temperature of 280° C. Further, the hydrogenated product (b1) of the triblock copolymer obtained in Production Example 2 was supplied to a T die at an extrusion screw temperature of 200° C. The crystallizable COP resin (a1) and the hydrogenated product (b1) of the triblock copolymer described above were discharged from the T die at a die extrusion temperature (multi-manifold) of 280° C. and cast on a cooling roll of which the temperature had been adjusted at 60° C. to obtain a film having a layer configuration of A layer (a1)/B layer (b1). Extrusion conditions were adjusted so that the thickness of the A layer became 15 μm and the thickness of the B layer became 11 μm. The obtained film was annealed in an oven at 170° C. for 30 seconds to obtain an optical layered film. The obtained optical layered film was subjected to the tear strength, the bend resistance test, and the chemical resistance test by the aforementioned methods.

### Example 2

An extruder equipped with a first T die, a second T die, and a third T die was prepared.

The crystallizable COP resin (a1) obtained in Production Example 1 was supplied to the first T die and the third T die at an extrusion screw temperature of 280° C. The hydrogenated product (b1) of the triblock copolymer obtained in Production Example 2 was supplied to the second T die at an extrusion screw temperature of 200° C. The crystallizable COP resin (a1) and the hydrogenated product (b1) of the triblock copolymer described above were discharged from the first to the third T dies at a die extrusion temperature (multi-manifold) of 280° C. and cast on a cooling roll of which the temperature had been adjusted at 60° C. to obtain a film having a layer configuration of B layer (b1)/A layer (a1)/B layer (b1). Extrusion conditions were adjusted so that the thickness of the A layer became 15 μm and the thickness of each of the two B layers became 11 μm. The obtained film was annealed in an oven at 170° C. for 30 seconds to obtain an optical layered film. The obtained optical layered film was subjected to the tear strength, the bend resistance test, and the chemical resistance test by the aforementioned methods.

### Example 3

An optical layered film having a layer configuration of A layer (a2)/B layer (b1) was obtained and evaluated by the same manner as that of Example 1 except for the following items.
The PET resin (a2) obtained in Production Example 5 was used instead of the crystallizable COP resin (a1)
Extrusion conditions were adjusted so that the thickness of the A layer became 50 μm and the thickness of the B layer became 11 μm.

### Example 4

An optical layered film having a layer configuration of A layer (a1)/B layer (b1-s) was obtained and evaluated by the same manner as that of Example 1 except for the following items.
The alkoxysilyl group-modified product (b1-s) obtained in Production Example 3 was used instead of the hydrogenated product (b1) of the triblock copolymer
Extrusion conditions were adjusted so that the thickness of the A layer became 15 μm and the thickness of the B layer became 15 μm.

### Example 5

An optical layered film having a layer configuration of B layer (b1-s)/A layer (a1)/B layer (b1-s) was obtained and evaluated by the same manner as that of Example 2 except for the following items.
The alkoxysilyl group-modified product (b1-s) obtained in Production Example 3 was used instead of the hydrogenated product (b1) of the triblock copolymer
Extrusion conditions were adjusted so that the thickness of the A layer became 15 μm and the thickness of each of the two B layers became 15 μm.

### Example 6

An optical layered film having a layer configuration of A layer (a1)/B layer (b2) was obtained and evaluated by the same manner as that of Example 1 except for the following items.
The resin (b2) containing the alkoxysilyl group-modified product (b1-s) obtained in Production Example 4 was used instead of the hydrogenated product (b1) of the triblock copolymer
Extrusion conditions were adjusted so that the thickness of the A layer became 15 μm and the thickness of the B layer became 15 μm.

### Comparative Example 1

### (Production of B Layer)

28 g of the pellets of the hydrogenated product (b1) of the triblock copolymer obtained in Production Example 3 and 60 g of cyclohexane were mixed, and the pellets were dissolved to prepare a 40% polymer solution. The obtained polymer solution was applied onto a release surface of a polyethylene terephthalate (PET)-made release film (thickness of 50 μm) of which the surface was subjected to the release treatment. The coating thickness of the solution was adjusted so that the thickness of the obtained B layer became 11 μm. After the application, the applied product was dried on a hot plate at 110° C. for 30 minutes to form a layered body having a layer configuration of release film (PET)/B layer (b1).

(Production of a Layer)

Further, as the A layer formed of the thermoplastic resin A, a film of a resin (a3) including an alicyclic structure-containing polymer (hereinafter, the resin including the alicyclic structure-containing polymer is also referred to as an alicyclic structure-containing resin) with a thickness of 25 μm (“ZeonorFilm ZF16” manufactured by ZEON Corporation) was prepared. The alicyclic structure-containing resin (a3) is amorphous and has a glass transition temperature Tg of 160° C. A film having a thickness of 4 mm and a film having a thickness of 1.5 mm were formed of the alicyclic structure-containing resin (a3). The flexural modulus and the tensile break elongation of these film measured by the aforementioned methods were 2,500 MPa and 10%, respectively.

One surface of the A layer to which the B layer was to be bonded was subjected to a corona treatment with an output that caused the water contact angle to be 45 degrees or less.

(Layering Step)

Subsequently, a press machine with a press roll heated to 70 degrees was prepared, and the A layer and the B layer were bonded to each other so that the corona treated surface of the A layer faced the B layer, thereby obtaining a layered film having a configuration of release film (PET)/B (b1)/A layer (a3). Then, after removing the release film, a film having a configuration of B layer (b1)/A layer (a3) was obtained. The obtained film was annealed in an oven at 170° C. for 30 seconds to obtain an optical layered film. The obtained optical layered film was subjected to the tear strength, the bend resistance test, and the chemical resistance test by the aforementioned methods.

### Comparative Example 2

As the B layer formed of the thermoplastic resin B, a layered body having a layer configuration of release film (PET)/B layer (b1) was prepared in the same manner as in (Production of B layer) in Comparative Example 1.

As the A layer formed of the thermoplastic resin A, a film of the alicyclic structure-containing resin (a3) with a thickness of 25 μm (“ZeonorFilm ZF16” manufactured by ZEON Corporation) was prepared.

Both surfaces of the A layer were subjected to a corona treatment with an output that caused the water contact angle to be 45 degrees or less. After that, a press machine with a press roll heated to 70 degrees was prepared, and the A layer and two B layers were bonded to each other to obtain a film having a layer configuration of release film (PET)/B layer (b1)/A layer (a3)/B layer (b1)/release film (PET). After that, the release films were removed. The obtained film was annealed in an oven at 170° C. for 30 seconds to obtain an optical layered film. The obtained optical layered film was subjected to the tear strength, the bend resistance test, and the chemical resistance test by the aforementioned methods.

### Comparative Example 3

The crystallizable COP resin (a1) obtained in Production Example 1 was supplied to a T die at an extrusion screw temperature of 280° C., discharged from the T die at a die extrusion temperature of 280° C., and cast on a cooling roll of which the temperature had been adjusted at 60° C. to produce the A layer formed of the crystallizable COP resin (a1) with a thickness of 15 μm.

One of the release films was peeled off from the tackiness sheet including the tackiness agent layer having a thickness of 10 μm obtained in Production Example 6. The tackiness agent layer exposed by peeling was bonded to one surface of the A layer and then the other release film was peeled off. In this manner, a film having a layer configuration of the tackiness agent layer (c1)/A layer (a1) was obtained. The obtained film was annealed in an oven at 170° C. for 30 seconds to obtain an optical layered film. The obtained optical layered film was subjected to the tear strength, the bend resistance test, and the chemical resistance test by the aforementioned methods.

The results of Examples and Comparative Examples described above are shown in the following Tables. Meanings of the abbreviations in the following Tables are as follows.

“c-COP”: crystallizable COP resin (a1)

“PET”: polyethylene terephthalate resin (a2)

“ZF16”: amorphous alicyclic structure-containing resin (a3)

“b1”: hydrogenated product (b1) of triblock copolymer

“b1-s”: alkoxysilyl group-modified product (b1-s) of hydrogenated product of triblock copolymer

“b2”: resin (b2) including alkoxysilyl group-modified product of hydrogenated product of triblock copolymer and hydrogenated polybutene

“c1”: tackiness agent (c1)

“S_{A}”: tensile break elongation of thermoplastic resin A

“E_{A}”: flexural modulus of thermoplastic resin A

“E_{B}”: flexural modulus of thermoplastic resin B

“*1”: change observed in cyclohexane as test liquid.

TABLE 1

| | Ex. 1 | Ex. 2 | Ex. 3 | Ex. 4 | Ex. 5 | Ex. 6 |
|---|---|---|---|---|---|---|
| layer configuration | B/A | B/A/B | B/A | B/A | B/A/B | B/A |
| thickness of each layer | | | | | | |
| B layer (μm) | 11 | 11 | 11 | 15 | 15 | 15 |
| A layer (μm) | 15 | 15 | 50 | 15 | 15 | 15 |
| B layer (μm) | — | 11 | — | — | 15 | — |
| thermoplastic resin A | c-COP | c-COP | PET | c-COP | c-COP | c-COP |
| S_{A} (%) | 145 | 145 | 114 | 145 | 145 | 145 |
| E_{A} (Pa) | 2800 | 2800 | 2300 | 2800 | 2800 | 2800 |
| thermoplastic resin B | b1 | b1 | b1 | b1-s | b1-s | b2 |
| E_{B} (MPa) | 680 | 680 | 680 | 680 | 680 | 520 |
| tear strength (N/mm) | 1.6 | 1.8 | 1.5 | 1.8 | 2 | 1.6 |
| presence/absence of line after | no line | no line | no line | no line | no line | no line |
| the first bending operation | | | | | | |
| bending times N(×1000 times) | 200 | 200 | 100 | 200 | 200 | 200 |
| presence/absence of crack after | no | no | no | no | no | no |
| N times bending operations | crack | crack | crack | crack | crack | crack |
| result of chemical resistance test | no | no | no | no | no | no |
| | change | change | change | change | change | change |

TABLE 2

| | Comp. Ex. 1 | Comp. Ex. 2 | Comp. Ex. 3 |
|---|---|---|---|
| layer configuration | B/A | B/A/B | B/A |
| thickness of each layer | | | |
| B layer (μm) | 11 | 11 | 10 |
| A layer (μm) | 25 | 25 | 15 |
| B layer (μm) | — | 11 | — |
| thermoplastic resin A | ZF16 | ZF16 | c-COP |
| S_{A} (%) | 10 | 10 | 145 |
| E_{A} (MPa) | 2500 | 2500 | 2800 |
| thermoplastic resin B | b1 | b1 | c1 |
| E_{B} (MPa) | 680 | 680 | 50 |
| tear strength (N/mm) | 1.1 | 1.2 | 1.2 |
| presence/absence of line after | lined | lined | lined |
| the first bending operation | | | |
| bending times N (×1000 times) | 3 | 5 | 200 |
| presence/absence of crack after | crack | crack | no crack |
| (N × 1000) times bending | | | |
| operations | | | |
| result of chemical resistance test | changed^{*1} | changed^{*1} | no change |

The aforementioned results show the following matters.

In the optical layered films according to Examples 1 to 6, each including the A layer formed of the thermoplastic resin A with a flexural modulus E_{A} of 1,900 MPa or more and 3,500 MPa or less and a tensile break elongation S_{A} of 100% or more, and the B layer, disposed on the A layer, with an flexural modulus E_{B} of 100 MPa or more and 900 MPa or less, no line was generated after the first bending operation and no crack was observed even after 100×1,000 times bending operations, proving excellent bend resistance. Further, they exhibit excellent chemical resistance and have satisfactory tear strength of 1.3 or more.

In the optical layered films according to Examples 1, 2, and 4 to 6, each using the resin including the alicyclic structure-containing polymer having crystallizability as the thermoplastic resin A, no crack was observed even after 200×1,000 times bending operations, proving particularly excellent bend resistance.

On the other hand, the optical layered films according to Comparative Examples, a line was generated after the first bending operation, proving poor bend resistance.

The aforementioned results show that the optical layered film of the present invention has excellent bend resistance.

### REFERENCE SIGN LIST

100 optical layered film
101 A layer
101U surface
101D surface
102 B layer
200 optical layered film
201 A layer
201U surface
201D surface
202 first B layer
203 second B layer
T test piece
E1 end portion
E2 end portion
C1 upper chuck
C2 lower chuck
D distance

1. An optical layered film comprising an A layer formed of a thermoplastic resin A and a B layer formed of a thermoplastic resin B provided on at least one surface of the A layer, wherein
a flexural modulus of a film of the thermoplastic resin A having a thickness of 4 mm is 1,900 MPa or more and 3,500 MPa or less,
a flexural modulus of a film of the thermoplastic resin B having a thickness of 4 mm is 100 MPa or more and 900 MPa or less, and
a tensile break elongation of a film of the thermoplastic resin A having a thickness of 1.5 mm is 100% or more.

2. The optical layered film according to claim 1, wherein the thermoplastic resin A includes a polymer having crystallizability.

3. The optical layered film according to claim 1, wherein the thermoplastic resin A includes an alicyclic structure-containing polymer.

4. The optical layered film according to claim 1, wherein the thermoplastic resin B includes a hydrogenated product of a block copolymer of an aromatic vinyl compound and a conjugated diene compound.

5. The optical layered film according to claim 1, wherein the thermoplastic resin B includes an alkoxysilyl group-modified product of a hydrogenated product of a block copolymer of an aromatic vinyl compound and a conjugated diene compound.

6. The optical layered film according to claim 1, wherein a thickness of the A layer is 50 μm or less.

7. An electroconductive film comprising the optical layered film according to claim 1, and an electroconductive layer.
